(19) United States
(12) Patent Application Publication
(10) Pub. No.: US 2016/0289088 A1
(43) Pub. Date: Oct. 6, 2016

(54) METHODS OF MAINTAINING THE CONCENTRATION OF AT LEAST ONE OXYGEN SPECIES WITHIN A WATER-BASED STREAM

(71) Applicant: BAKER HUGHES INCORPORATED, Houston, TX (US)

(72) Inventors: Hua Mo, Friendswood, TX (US); Roger D. Metzler, Sugar Land, TX (US); Simon Cornelius, Tomball, TX (US)

(73) Assignee: BAKER HUGHES INCORPORATED, Houston, TX (US)

(21) Appl. No.: 15/084,132

(22) Filed: Mar. 29, 2016

Related U.S. Application Data
(60) Provisional application No. 62/141,611, filed on Apr. 1, 2015.

(51) Int. Cl. C02F 1/00

(52) U.S. Cl. CPC C02F 1/008; C02F 2209/22; C02F 2303/08

(57) ABSTRACT

A concentration of at least one oxygen species may be maintained within a pre-determined range in a water-based stream by obtaining at least one measurement as a direct current (DC) output with at least one probe within the water-based stream. The measurement(s) may correlate to a measured concentration of the oxygen specie(s) within the water-based stream. The measured concentration of the oxygen specie(s) within the water-based stream may be altered when the measured concentration is outside the pre-determined range.

### CROSS-REFERENCE TO RELATED APPLICATION

This application claims the benefit of U.S. Patent Application Ser. No. 62/141,611 filed Apr. 1, 2015, incorporated herein by reference in its entirety.

### TECHNICAL FIELD

The present invention relates to methods and apparatus for maintaining an oxygen concentration in a water-based stream, and more particularly relates to methods and apparatus for maintaining a concentration of at least one oxygen species within a pre-determined range in a water-based stream by obtaining an output with at least one probe within the water-based stream.

### BACKGROUND

Dissolved oxygen in a water-based stream causes subsequent reactions within the water-based stream and potential fouling and/or corrosion of the process equipment and piping, such as peroxide related free radical polymerization etc. ‘Water-based stream’ is defined herein to include refinery water-based streams being processed, as well as refinery water-based streams in tankage, and the like; wastewater streams; and combinations thereof. Such water-based streams may also be or include water-based streams in the vapor phase, liquid phase and mixed phase streams.

The oxygen intrusion may happen in many ways, such as from a vacuum distillation tower, a cooling water leak, a makeup solvent, storage tank of chemicals, and the like. Dissolved oxygen is a relative measure of the amount of oxygen dissolved or present in a given medium, i.e. oxygen saturation within a water-based fluid. Oxygen monitoring may be used to determine the trend of the oxygen level, or to measure the oxygen reactant concentration in order to determine the need for oxygen scavengers, antioxidants, or other oxygen reactive inhibitor additives (hereinafter collectively referred to as “oxygen scavengers”).

A common prior art method of measuring dissolved oxygen may use a galvanic (voltage) sensor and/or an amperometric (current) sensor. Specifically, oxygen ions are reduced at the cathode in the sensor, generating either a potential or current. However, the sensor can become coated by the process or can change due to structural failure, such as cracks, leakage, and/or degradation. In the sensor body, the physical condition of the electrodes and the condition of the electrolyte directly affect the sensor signal current.

Therefore, it would be beneficial to devise better methods to determine a concentration of oxygen species in water-based fluids for monitoring and/or maintaining the concentration of the oxygen species therein.

### SUMMARY

There is provided, in one form, a method for maintaining a concentration of at least one oxygen species within a pre-determined range in a water-based stream. The method may include obtaining at least one measurement as a direct current (DC) output with at least one probe within the water-based stream where the measurement correlates to a measured concentration of the oxygen species within the water-based stream. The method may further include determining that the measured concentration is outside the pre-determined range and altering the concentration of the at least one oxygen species so that the measured concentration of the at least one oxygen species within the water-based stream is within the pre-determined range.

In an alternative non-limiting embodiment of the method, the measurement may be a luminescence measurement, and the DC output may be proportional to an amount of the oxygen species within the water-based stream to quantify a measured concentration of the at least one oxygen species within the water-based stream.

There is provided, in another non-limiting embodiment, a system for maintaining a concentration of at least one oxygen species within a pre-determined range in a water-based stream. The system may include at least one probe disposed in the water-based stream; at least one piece of equipment selected from the group consisting of an aerator, a mixing nozzle, a chemical injector, and combinations thereof; and a water-based stream. The probe may be configured to detect at least one measurement selected from the group consisting of a transmittance measurement, a reflectance measurement, a fluorescence measurement, a luminescence measurement, and combinations thereof within the water-based stream. The probe may be configured to output the measurement as a direct current (DC) output to the equipment. The DC output may be proportional to a concentration of the oxygen species within the water-based stream to quantify a measured concentration of the oxygen species within the water-based stream. The equipment may be configured to receive the DC output and may be configured to alter the measured concentration of the oxygen species within the water-based stream when a measured concentration is outside the pre-determined range.

The DC output from the probe provides a quicker and less expensive mechanism to determine a concentration of oxygen species within a water-based stream than conventional methods.

### DETAILED DESCRIPTION

It has been discovered that a concentration of at least one oxygen species may be maintained within a pre-determined range in a water-based stream. The method may include obtaining at least one measurement as a direct current (DC) output with at least one probe within the water-based stream where the measurement(s) correlate to a measured concentration of the oxygen specie(s) within the water-based stream. If the concentration is outside the pre-determined range, the measured concentration of the oxygen specie(s) within the water-based stream may be altered by appropriate processes and equipment. In a non-limiting example, the DC output may linearly correlate to the concentration of the oxygen specie(s) within the water-based stream. The use of DC output may allow for quicker, if not immediate, altering of the concentration to occur by the equipment in real-time and/or online to allow for better monitoring and/or maintenance of the oxygen species concentration within the water-based stream. In a non-limiting embodiment, the dissolved oxygen species may be dissolved oxygen (O₂).

‘Online’ is defined herein to refer a system where the altering by the equipment is under direct control from the measured concentration(s) received from the probe. Obtaining the measurements of the oxygen species within the water-based fluid would allow for immediate altering of the measured concentration by the equipment without human intervention. ‘Output’ is defined as information that is sent from the probe and is received by the equipment and/or at an intermediate location.

To take the measurement(s), the probe may be introduced into the water-based stream, and the probe may take at least one measurement, such as at least one fluorescence measurement, at least one luminescence measurement, at least one transmittance measurement, at least one reflectance measurement, and/or combinations thereof. The measurement(s) may be converted into a concentration measurement of dissolved oxygen species within the water-based stream. The concentration measurement may be compared to a pre-determined concentration range for the concentration of the oxygen specie(s) within the water-based stream. If the concentration measurement is above the upper limit or below the lower limit of the pre-determined concentration range, the equipment may alter the concentration of the oxygen specie(s) within the water-based stream.

The measurement(s) of the water-based stream may be outputted or transmitted from the probe to the equipment via a connection that may be a wired connection and/or a wireless connection. In a non-limiting example, software may be used to determine a measured concentration of the oxygen species within the water-based stream from the measurement(s).

In a non-limiting embodiment, the measurement(s) may be outputted to an intermediate location, such as but not limited to, a personal computer, a smart phone, a web-based software program, and combinations thereof. The intermediate location may allow for a user to view the measured concentration of the oxygen species within the water-based stream, and optionally, input a manual override to alter the concentration of the oxygen species within the water-based stream that would not have occurred but for the user override. The intermediate location may also allow for storage of the measurement(s) and/or concentration data.

In a non-limiting embodiment, the equipment may be or include an aerator, a chemical injector, a mixing nozzle, and/or combinations thereof. The rate of aeration may be increased to increase the amount of oxygen specie(s) within the water-based stream, or the rate of aeration may be decreased to decrease the amount of oxygen specie(s) within the water-based stream. Said differently, when the measured concentration is below the lower limit of the pre-determined range for the concentration, the rate of aeration may be increased within the aerator. When the measured concentration is above the upper limit of the pre-determined range for the concentration, the rate of aeration may be decreased within the aerator.

Similarly, a chemical injector may inject at least one chemical into the water-based stream to cause an increase or decrease in the concentration of oxygen specie(s) within the water-based stream. The chemical injector may inject a chemical into the water-based stream to chemically alter the concentration of the oxygen specie(s) within the water-based stream. When the measured concentration is below the lower limit of the pre-determined range for the concentration, a chemical may be introduced into the water-based stream to increase the concentration of dissolved oxygen species therein. When the measured concentration is above the upper limit of the pre-determined range for the concentration, a chemical may be introduced into the water-based stream to decrease the concentration of dissolved oxygen specie(s) therein.

In a non-limiting embodiment, the chemical may be an oxygen scavenger. The amount of the oxygen scavenger(s) within the water-based stream may range from about 0.1 ppm independently to about 150 ppm, alternatively from about 1 ppm independently to about 100 ppm, in another non-limiting embodiment. “Oxygen scavenger” is defined herein to be any compound that targets the oxygen species and reduces or prevents the ability of the oxygen species to react with other species present in the hydrocarbon stream. Non-limiting examples of oxygen scavengers may be or include oxygen antioxidants, oxygen species inhibitors, or other oxygen reactive inhibitor additives. Non-limiting examples of the oxygen scavengers may be or include, but are not limited to phenylene diamine, phenols, hydroxyl amine, erythobic acid, hydrazine, and combinations thereof.

The pre-determined concentration of the oxygen specie(s) within the water-based fluid may range from about 4 ppm independently to about 50 ppm, alternatively from about 0.1 ppm independently to about 50 ppm; alternatively from about 0.5 ppm independently to about 20 ppm; and in another non-limiting embodiment from about 1 ppm independently to about 10 ppm in another non-limiting embodiment.

In a non-limiting embodiment, the efficacy of the oxygen scavenger in the water-based stream may be tested by measuring the water-based stream to determine a base-line concentration of oxygen species within the water-based stream without the presence of an oxygen scavenger. Then, the oxygen scavenger may be added to the water-based stream, and the concentration of the oxygen species may be determined from the probe measurement(s) to compare the concentration of oxygen species within the water-based stream with and without the oxygen scavengers. If the measured concentration of oxygen specie(s) within the water-based stream with the oxygen scavenger(s) is not less than the measured concentration of oxygen species within the water-based stream without the scavenger(s), the dosage of the oxygen scavenger may need to be increased or substituted for another type of oxygen scavenger.

Quantifying the amount of oxygen species in the water-based stream is important for several reasons. When the oxygen species combine with other chemical and/or biological species within the water-based stream, this may cause fouling and corrosion within the stream and also to the equipment used for handling the water-based stream. By using the probe measurement(s) to quantify oxygen species in the water-based stream, rapidly time-varying signals may be measured. The measurements may also be taken on-line or offline, and even at a remote location.

To use the probe(s), a light may be passed through the water-based stream once the probe(s) are introduced therein. The water-based stream may have at least one probing additive present to aid the probe(s) in obtaining the measurement(s). The probing additive may be present in the water-based stream or added to the water-based stream in an amount ranging from about 0.1 ppm independently to about 50 vol %, or from about 0.1 ppm independently to about 20 vol %. In another non-limiting embodiment, the probing additive may range from about 0.1 ppm independently to about 10 vol %. In a non-limiting embodiment, the probing additive may be coated onto the probe.

The probing additive(s) may be or include at least one luminophore, such as, but not limited to, platinum, palladium, ruthenium, ytterbium, salts thereof, porphyrins thereof, monoaromatic derivatives thereof, polyaromatic derivatives thereof, and combinations thereof. The salts may be or include, but are not limited to, chlorides, perchlorides, sulfates, bipyridines, and combinations thereof etc. The porphyrins may be or include, but are not limited to, halogenated porphyrins, oxygenated porphyrins, and combinations thereof. The monoaromatic derivative may have a phenyl. The polyaromatics may be or include, but are not limited to naphthalene and anthracene, and combinations thereof.

More generally, luminophores have been used to facilitate optical sensing. As used herein, a “luminophore” is a chemical species that reacts to the presence of a substance to produce an optical result, e.g. a fluorophore. Another type of luminophore changes color in accordance with changes in an amount of a particular substance.

Luminophores may be trapped in a solid substance and deposited as a thin layer or a membrane onto a fiber optic waveguide where the waveguide and the trapped luminophore form a fiber optic probe. The probe may be introduced into the water-based stream, or a sample of the water-based stream may be taken, so the probe may interact with the oxygen species, which results in a change in luminescence properties. This change may be probed and detected through the fiber optic waveguide by an optical detector. The optical detector may be a single photodetector with an optical filter, a spectrometer, or any optical detection system capable of measuring light intensity or the change in light intensity through time. These optical properties of chemical sensor compositions typically involve changes in colors or in color intensities, fluorescence intensity, or fluorescence lifetime.

With these types of probes, it is possible to detect changes in the water-based streams being monitored at the tip of the fiber sensor by a detector that is located remotely to the sample, in order to thereby provide remote monitoring capabilities. In such systems, the amount of light reaching the detector may limit the sensitivity and signal-to-noise ratio of the measurement.

In another non-limiting embodiment, fiber optic devices may allow for miniaturization and remote sensing of water-based streams. The luminophore may be immobilized via mechanical or chemical means to one end of an optical fiber, and the opposite end of the fiber may have a fiber coupler (Y shaped fiber) or a beam splitter attached thereto. Incident excitation light may be coupled into one leg of the fiber by a filter and a lens. Excitation light may be carried through the fiber to the distal end where the luminophore is immobilized to the tip.

Upon excitation, the luminophore may uniformly radiate the fluorescent light, some of which is recaptured by the fiber tip and propagated back through the fiber to the junction or “coupler”. At the junction, a substantial portion (typically half) of the fluorescence may be conveyed back to the emitter or point of origin thereby unavailable for signal detection. To offset the inefficiencies of the system, lasers may be used to raise the input power, and highly sensitive photomultiplier tubes may be used as detectors. The other half of the fluorescence may travel along the other leg of the fiber to the detector to be recorded. Non-limiting examples of suitable probes that may be used to detect oxygen in water-based fluids include, but are not necessarily limited to, Vernier Optical DO probe sold by Vernier Software & Technology in Beaverton, Oregon; OCEAN OPTIC™ NEOFOX-KIT-PROBE; HACH™, IN-SITU™, YSI™ and ROD PRO-X dissolved oxygen probe from In-Situ: https://in-situ.com/products/water-quality-testing-equipment/rdo-pro-x-dissolved-oxygen-probe/

The light used in conjunction with the probe to aid in obtaining the measurement(s), e.g. fluorescence of the probing additives, may have a wave-length ranging from about 350 nm independently to about 550 nm in another non-limiting embodiment; alternatively from about 400 nm independently to about 600 nm. The probing additive(s) may be added directly to the water-based stream in a pre-determined amount, coated onto the probe(s), or both. In the instance that the probe has the probing additive coated thereonto, and the probing additive has been directly added to the water-based stream, the amount of probing additive added to the water-based stream may be much less than the amounts mentioned above. As used herein with respect to a range, “independently” means that any lower threshold may be used together with any upper threshold to give a suitable alternative range.

In a non-limiting embodiment, the probe may be or include a dissolved oxygen probe supplied by VERNIER™, which may be found at http://www.verniercom/products/sensors/dissolved-oxygen-probes/; alternatively other suitable probes include, but are not necessarily limited to, HACH™, IN-SITU™, YSI™; OCEAN OPTIC™ NEOFOX-KIT-PROBE; ROD PRO-X dissolved oxygen probe from In-Situ. In a non-limiting embodiment, a dissolved oxygen probe may output voltage or current proportional to the dissolved oxygen concentration in a water-based stream. When the oxygen level decreases below a pre-determined level, the output voltage may be an “on” switch to turn on an aerator and introduce additional oxygen into the water-based fluid and/or water-based stream. When the oxygen level becomes higher than a certain level, the output voltage may be an “off” switch to turn off the aerator and discontinue any introduction of additional oxygen into the water-based fluid and/or water-based stream. The measured voltage will depend on the oxygen level in the water. Therefore the rate of oxygen to put in the water system through aerator can be adjusted with the changing of voltage.

In the foregoing specification, the invention has been described with reference to specific embodiments thereof, and has been described as effective in providing methods for maintaining a concentration of at least one oxygen species within a pre-determined range in a water-based stream. However, it will be evident that various modifications and changes can be made thereto without departing from the broader scope of the invention as set forth in the appended claims. Accordingly, the specification is to be regarded in an illustrative rather than a restrictive sense. For example, specific water-based fluids or streams, probes, equipment, types of measurements, luminophores, solvents, salts, probing additives, and oxygen species falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method for maintaining a concentration of at least one oxygen species within a pre-determined range in a water-based stream may consist of or consist essentially of obtaining at least one measurement as a direct current (DC) output with at least one probe within the water-based stream where the measurement correlates to a measured concentration of the oxygen species within the water-based stream; determining that the measured concentration is outside the pre-determined range; and altering the concentration of the at least one oxygen species so that the measured concentration of the at least one oxygen species within the water-based stream is within the pre-determined range.

The system for maintaining a concentration of at least one oxygen species within a pre-determined range in a water-based stream may consist of or consist essentially of at least one probe disposed in the water-based stream, at least one piece of equipment selected from the group consisting of an aerator, a chemical injector, a mixing nozzle, and combinations thereof, and a water-based stream; the probe may be configured to detect at least one measurement selected from the group consisting of a transmittance measurement, a reflectance measurement, a fluorescence measurement, a luminescence measurement, and combinations thereof within the water-based stream; the probe may be configured to output the measurement as a direct current (DC) output to the equipment; the DC output may be proportional to a concentration of the oxygen species within the water-based stream to quantify a measured concentration of the oxygen species within the water-based stream; the equipment may be configured to receive the DC output and may be configured to alter the measured concentration of the oxygen species within the water-based stream when a measured concentration is outside the pre-determined range.

The words “comprising” and “comprises” as used throughout the claims, are to be interpreted to mean “including but not limited to” and “includes but not limited to”, respectively. As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for maintaining a concentration of at least one oxygen species within a pre-determined range in a water-based stream, the method comprising:
obtaining at least one measurement as a direct current (DC) output with at least one probe within the water-based stream; where the at least one measurement correlates to a measured concentration of the at least one oxygen species within the water-based stream;
determining that the measured concentration is outside the pre-determined range; and
altering the concentration of the at least one oxygen species so that the measured concentration of the at least one oxygen species within the water-based stream is within the pre-determined range.

2. The method of claim 1, where the measurement is selected from the group consisting of a fluorescence measurement, a luminescence measurement, a transmittance measurement, a reflectance measurement, and combinations thereof.

3. The method of claim 1, where the altering occurs by a process selected from the group consisting of altering a rate of aeration by an aerator, injecting at least one oxygen scavenger into the water-based stream to at least partially increase or decrease the at least one oxygen species from the water-based stream, and combinations thereof.

4. The method of claim 1, where the pre-determined range is from about 0.1 ppm to about 50 ppm.

5. The method of claim 1, where the water-based stream comprises at least one probing additive.

6. The method of claim 5 further comprising adding the at least one probing additive into the water-based stream in an amount ranging from about 0.1 ppm to about 50 vol % prior to the obtaining at least one measurement.

7. The method of claim 5, where the at least one probing additive is coated onto the at least one probe.

8. The method of claim 1, where the water-based stream further comprises at least one oxygen scavenger.

9. The method of claim 1, where the at least one oxygen species is dissolved oxygen (O₂).

10. The method of claim 1, where the water-based stream is a refinery stream, a wastewater stream, and combinations thereof.

11. A method for maintaining a concentration of at least one oxygen species within a predetermined range in a water-based stream, the method comprising:
obtaining at least one luminescence measurement as a direct current (DC) output with at least one probe within the water-based stream; where the DC output is proportional to an amount of the at least one oxygen species within the water-based stream to quantify a measured concentration of the at least one oxygen species within the water-based stream;
determining that the measured concentration is outside the pre-determined range; and
altering the concentration of the at least one oxygen species so that the measured concentration of the at least one oxygen species within the water-based stream is within the pre-determined range, where the altering occurs by a process selected from the group consisting of altering a rate of aeration by an aerator, injecting at least one oxygen scavenger into the water-based stream to at least partially increase or decrease the at least one oxygen species from the water-based stream, and combinations thereof;
where the water-based stream is a refinery stream, a wastewater stream, and combinations thereof.

12. The method of claim 11, where the water-based stream comprises at least one probing additive in an amount ranging from about 0.1 ppm to about 50 vol % prior to obtaining the at least one measurement.

13. The method of claim 12 where the at least one probing additive is coated onto the at least one probe.

14. The method of claim 11, where the water-based stream further comprises at least one oxygen scavenger.

15. The method of claim 14, where the amount of the at least one oxygen scavenger within the water-based stream ranges from about 0.1 ppm to about 150 ppm.

16. The method of claim 12, where the at least one oxygen species is dissolved oxygen (O₂).

17. A system for maintaining a concentration of at least one oxygen species within a pre-determined range in a water-based stream comprising:
at least one probe disposed in the water-based stream; where the at least one probe is configured to detect at least one measurement selected from the group consisting of a transmittance measurement, a reflectance measurement, a fluorescence measurement, a luminescence measurement, and combinations thereof; and where the at least one probe is configured to output the at least one measurement as a direct current (DC) output to at least one piece of equipment; where the DC output is proportional to a concentration of the at least one oxygen species within the water-based stream to quantify a measured concentration of the at least one oxygen species within the water-based stream;
at least one piece of equipment selected from the group consisting of an aerator, a chemical injector, a mixing nozzle, and combinations thereof; where the at least one piece of equipment is configured to receive the DC output; and where the at least one piece of equipment is configured to alter the measured concentration of the at least one oxygen species within the water-based stream when a measured concentration is outside the pre-determined range; and
a water-based stream.

18. The system of claim 17, where the measurement is a luminescence measurement.

19. The system of claim 17, where the water-based stream further comprises at least one probing additive and where the at least one oxygen species is dissolved oxygen (O₂).
